(19) United States
(12) Patent Application Publication
(10) Pub. No.: US 2017/0316394 A1
(43) Pub. Date: Nov. 2, 2017

(54) Cross-Border Payment and Clearing System and Cross-Border Payment Method Based on Digital Currency

(71) Applicant: Ruilong ZHU, Changsha (CN)

(72) Inventor: Ruilong ZHU, Changsha (CN)

(21) Appl. No.: 15/525,273

(22) PCT Filed: Nov. 4, 2015
(86) PCT No.: PCT/CN2015/093742

§ 371 Date: May 8, 2017

(30) Foreign Application Priority Data
Nov. 6, 2014 (CN) 201410618716.8

(51) Int. Cl. G06Q 20/10; G06Q 20/08

(52) U.S. Cl. CPC G06Q 20/108; G06Q 20/0855

(57) ABSTRACT

A cross-border payment and clearing system and a cross-border payment and clearing method that are based on the Internet and that do not depend on messages. The system and the method get rid of an existing clearing system based on messages, and high speed and low cost cross-border payment and clearing are implemented by means of communication without messages that is based on the Internet and counterparty transaction of members, and further, a trilateral clearing mode is implemented that ordinary corporations, natural persons, and the like directly submit a cross-border payment request to the clearing system, and the clearing system performs real-time payment and clearing according to a member of a payment corporate that is appointed by the clearing system or that is preferred, so that a large number of intermediate links and message transmission are omitted, and efficiency is greatly improved. The system supports both legal currency clearing and digital currency clearing, and fully uses features of digital currency and locks, releases, and pays out security deposit, to further reduce a risk, and has important uses in the fields of currency clearing, international trade, cross-border electronic commerce, and the like.

### BACKGROUND OF THE PRESENT INVENTION

### Field of Invention

The present invention relates to internet, finance, internet-based and virtual currency system and method, and more particularly to an internet-based cross-border payment and clearing system and cross-border payment method based on digital or virtual currency, wherein this cross-border payment and clearing system and cross-border payment method is an enhanced and innovative upgrade of conventional cross-border payment and clearing system and cross-border payment method.

### Description of Related Arts

Conventionally, bitcoin is a leading form of digital currency and electronic payment system and it once was one of the most widely accepted cryptocurrency around the world. A major feature of digital currency is that is it completely virtual and relies on internet as a platform for accomplishing electronic transactions. At the same time, however, digital currency works as a medium of exchange and is therefore function as real money. Digital currency is created, issued and circulated through digital wallets, not traditional banks. It does not exist as real money or real cash, but exist as some sorts of digital formats circulated through internet. Thus, digital currency cannot be physically touched yet it exist everywhere in internet world.

Because digital currency is transacted and circulated through internet and in digital form, electronic payment systems using digital currency has become very convenient and rapid. Moreover, money transfer and payment may also be completed very rapidly without involving banks and independent of geographical locations between all relevant parties. All these make the costs of digital currency transaction very low. In addition, since all transactions involving digital currency may be encrypted with start-of-the-art cryptography and authentication technology, and may have very detailed and accurate transaction record stored through predetermined networks, digital currency thus have superior anti-counterfeiting features than that of real and physical currency. It is very difficult to imitate digital currency as compared to conventional physical money. All these make digital currency an ideal technology for being implemented to cross-border payment and clearing systems.

Conventional cross-border payments and transactions usually require several days to complete and clear. The entire process requires very high costing and involve an independent clearing processing system and procedures. The relevant banks and parties may not directly participate in using the clearing processing system and procedures. In international transactions clearing, relevant financial institutions may utilize a specific secured networks, such as the Society for Worldwide Interbank Financial Telecommunication (SWIFT), which enables them to send and receive transactions information in a standardized and regulated environment. In SWIFT environment, payment orders are sent through a telegraph-like network. Payment orders must be settled by correspondent accounts that the institutions have with each other. The cost for complete a transaction in SWIFT environment depend on the length and type of the payment orders and settlement notices. For example, wire transfer by banks around the world may charge approximately $100 transaction fee plus other miscellaneous fees. All these make the cost for cross-border transactions very expensive and inefficient, and pose a major disadvantage to cross-border transactions involving only relatively small amounts of money. Transactional communications through internet will avoid the above-mentioned problem. Internet may transmit a large amount of data, perhaps in the order of gigabytes, in very high speed and low costs.

Therefore, the present invention provides an internet-based cross-border payment and clearing system and cross-border payment method based on digital currency which are designed to facilitate more convenient cross-border transactions and to implement digital currency to commercial transactions involving daily life. As such, cross-border transactions may be realized in an environment which is speedier, possesses less risks and requires lower transaction and maintenance costs.

### TECHNICAL PROBLEMS

The present invention may resolve the following technical problems:

To establish an opened and accessible communication system so as to allow convenient real-time communications between a clearing system, a payment company or a bank, a user (a client having the need to be involved in cross-border transaction), and a receiving company. Real-time communications may also be established between all the participating banks, or all participating users. Cross-border transaction requests and the corresponding instructions and outcomes may be sent and communicated between all the involving parties in a real-time basis. Payment companies, banks and users may utilize internet to accomplish cross-border transactions without using any other specific communication networks and equipment.

To resolve the relatively non-transparent and closed nature which exist in conventional clearing systems. For example, when a user wishes to order a cross-border transaction, he may not directly initiate the transaction through an international clearing system. Rather, he can only initiate the cross-border transactions through an intermediary commercial bank, which needs to go through complicated and time-consuming clearing and approval process and to verify the account and funds status of the relevant user. The cross-border transaction may only be initiated after all these complicated processes and verifications are completed.

To establish a novel, open and direct international clearing transaction model, so as to allow a user to directly initiate a cross-border transaction request and application through a clearing system, which may then rapidly complete the cross-border transaction in an effective and efficient manner. This will avoid the need to have complicated verification process and exchange of transactions-related messages through telegraph-like and old-fashioned network.

To fully utilize the advantages of digital currency for accomplishing rapid and efficient clearing, and to minimize the risks involved regarding the variations of exchange rate of the relevant digital currency.

### SUMMARY OF THE PRESENT INVENTION AND TECHNICAL DETAILS

The present invention provides an internet-based cross-border payment and clearing system with a brand new clearing pattern. The present invention improves upon conventional international clearing systems and methods in which a large amount of messages is transmitted through old-fashioned networks. The present invention allows a user (such as an international trader) to directly initiate a cross-border transaction through a clearing system which may rapidly execute such a cross-border transaction without going through initialization process in banks. This substantially avoids many unnecessary steps and processes and exchange and transmission of transaction messages. Moreover, the present invention also establish a system involving participating or member banks and security deposits paid by participating members or parties. When deficiencies or abnormality in transactions occur, the security deposits, which may include actual funds or digital currency, may be deducted to compensate the relevant deficiencies. The present invention may also determine or allow the maximum amount of cross-border transactions by the amount paid as security deposits by a particular user of the present invention. This undoubtedly minimize any transaction risks which may occur to the relevant parties.

The present invention mainly comprises:

An internet-based cross-border payment and clearing system which comprises a core database, a member interface and/or a client terminal, characterized in that:

1. comprising a member system, a member of the member system comprises a transaction processing company for payment processing;

2. comprising an internet-based non-telegraphic command transmission and communication system, which includes wireless internet-based command transmission and communication system, for accomplishing communications between two or more of the group consisting of member, clearing system and user, and/or communications between members and communications between users;

3. comprising a business system, wherein the members carry out counterparty transactions with other members through the business system to conduct cross-border payment. The counterparty transactions may include payment processing. The payment processing may be conducted between members by using digital currency, and/or through the clearing system by using official currency and/or digital currency;

wherein feature 2 as mentioned above is the foundation and core of the internet-based cross-border payment and clearing system of the present invention. The internet-based cross-border payment and clearing system may allow members to access internal information and data of the clearing system, especially members or users who have the need to have cross-border transactions and payments. The internet-based cross-border payment and clearing system may also allow communications of information and instructions within the system without using telegraph message or telegraph communication networks.

An internet-based cross-border payment and clearing system for processing clearing which is initiated by external users directly, characterizes in that, it comprises an external business submission and processing system, wherein a legal entity, a natural person and/or an organizations, which may include non-member, may, submit a cross-border and payment and/or clearing request to the clearing system through the external business submission and processing system. The clearing system may process the cross-border payment and clearing transaction through a transaction processing company as designated, and/or arrange other transaction processing company to process the cross-border payment and/or clearing. The transaction processing company may include a transaction processing company on the payer side (payment company) and/or a company on the payee side (receiving company).

A cross-border payment and clearing system for processing clearing which is initiated by an external user, characterized in that such system may include the above-mentioned member system, the business system and/or the external business submission and processing system at the same time.

An internet-based non-telegraphic cross-border payment and clearing system, characterized in that the system may further comprise a preferred transaction counterparty matching system which is arranged to select the optimal transaction processing company for the user regarding a cross-border transaction or clearing. The selected transaction processing company includes a transaction processing company on the payer side or a transaction processing company on the payee side in the counterparty transaction

An internet-based non-telegraphic cross-border payment and clearing system, characterized in that the system may be configured to exchange an official currency paid by a user to another official currency or a digital currency, and transfer a predetermined amount of that official currency or the digital currency to a specified account or electronic wallet as designated by the user.

For example, if a user pays a predetermined amount of Renminbi, the cross-border payment and clearing system may exchange that currency to other official currencies such as Euro, U.S. dollars, a predetermined digital currency, precious metals, or even an appropriate bill of lading in bartering transaction.

An internet-based non-telegraphic cross-border payment and clearing system, characterized in that the system may comprise a member bank system and/or security deposit system for storing more than one type of official currency or digital currency, wherein a member or a user of the cross-border payment and clearing system may deposit a predetermined amount of security deposits to the member bank system and/or security deposit system, and when cross-border transactions is being processed, the cross-border payment and clearing system may performing one or more of locking, releasing, reimbursing and paying specific amount held in security deposits through the member bank system or security deposit system in which the security deposits may be in the form of official currency and/or digital currency.

An internet-based non-telegraphic cross-border payment and clearing system, characterized in that cross-border transactions may only be carried out when the amount held as security deposits is adequate.

An internet-based cross-border payment and clearing system, characterized in that the system may further comprise a financing system, the cross-border payment and clearing system provides financing services to members through the financing system.

An internet and digital currency based cross-border payment and clearing method, characterized in that the method may comprise the steps of:

a.1 appointing a payment company to conduct cross-border transaction and making payment by a client, as a member of a clearing system the appointed transaction processing company initiates cross-border payment or clearing request through the clearing system, and select a member company in the target country as an optimal transaction counterparty company, for this particular cross-border payment or clearing transaction through the clearing system or automatically by the clearing system, and carry out this counterparty transaction;

a.2 locking the security deposits of the transaction processing company and the transaction counterparty company by the clearing system;

a.3 paying digital currency corresponding to the amount of the payment from the appointed transaction processing company to the transaction counterparty company;

a.4 after the transaction counterparty company has received the digital currency, releasing or unlocking the corresponding amount from the relevant security deposits of the appointed transaction processing company by the clearing system;

a.5 transferring the corresponding official currency to a bank account designated by the client by the transaction counterparty company; and

a.6 after the full payment to the bank account is confirmed, releasing or unlocking the corresponding amount from the relevant security deposits of the transaction counterparty company by the clearing system and the transaction is completed.

An internet and digital currency based non-telegraphic cross-border payment and clearing method, characterized in that step a.1 may comprise the steps of:

at_1. submitting an application to the clearing system to conduct a cross-border payment and/or clearing by a natural person and/or a legal entity and/or an organization which is a non-member of the clearing system;

at_2. when the the natural person and/or the legal entity and/or the organization has designated a transaction processing companying the application, processing subsequent cross-border payment and/or clearing transaction with the designated transaction processing company by the clearing system in accordance with the instructions contained in the application, when no designated transaction processing company is included in the application, selecting the optimal matching transaction processing company by the clearing system automatically to complete the subsequent cross-border payment and clearing transaction; and

at_3. making payment to the selected transaction processing company on the payer side as designated by the legal entity and/or the natural person and/or the organization or as selected by the clearing system.

An internet and digital currency based cross-border payment and clearing method, characterized in that step a.3 and step a.5 may comprise the steps of:

a3_1. exchanging the payment from the client into a predetermined digital currency by the transaction processing company on the payer side;

a5_1. exchanging the digital currency into official currency by the transaction processing company on the payee side;

A tripartite real-time cross-border payment and clearing method which is based on direct application through internet and does not involve intermediate transaction, characterized in that the method comprises the steps of:

as1. submitting application to the clearing system to perform a cross-border payment and/or clearing transaction by a legal entity and/or a natural person and/or an organization which includes a non-member of the clearing system; and

as2. according to the application by the legal person and/or the natural person and/or the organization, processing subsequent cross-border and payment and clearing with the designated transaction processing company by the clearing system in accordance with the instructions contained in the application, or with the optimal transaction processing company selected by the clearing system, meanwhile locking a predetermined amount of a predetermined currency from the security deposits paid by the transaction processing company, the transaction processing company includes the transaction processing company on the payer side and the transaction processing company on the payee side;

as3. making payment to the transaction processing company on the payer side as designated by the legal entity and/or the natural person and/or the organization or as selected by the clearing system ;

as4. transferring a predetermined amount of currency corresponding to the amount in the security deposit in the transaction processing company on the payer side to a designated account of the transaction processing company on the payee side by the clearing system, and

as5. transferring a corresponding amount of official currency to the bank account designated earlier by the legal entity and/or a natural person and/or an organization from the account of the transaction processing company in the same bank;

An internet-based non-telegraphic cross-border payment and clearing method, characterized in that after step a2, simultaneously carrying out step a3, step a3_1, step a5 and step a5_1, and/or steps as4 and step as5.

An internet-based non-telegraphic cross-border payment and clearing method, characterized in that making an indemnity payment of a corresponding amount to a counterparty from the security deposit of the other counterparty when the other counterparty of the counterparty transaction fails to pay the corresponding amount of currency to the final target account or to the other counterparty as requested.

The present invention as described above may have the following advantageous effects:

The present invention improves upon conventional clearing system which is closed and telegraph-based, and establishes an internet-based and relatively opened clearing system for facilitating rapid and efficient cross-border transactions and payments between users, the relevant clearing system, participating banks and participating payment and receiving company. The present invention eliminates the need of complicated clearing procedures and processing of telegraph-like messages. The present invention is particularly effective and efficient to handle small-amount cross-border transactions and payments. Since the amount of small-amount cross-border transactions and payments is expected to be increasing very rapidly in the near future, the present invention will be very significant in the area of international trade and commerce.

At the same time, the present invention also provides a novel cross-border clearing and payment pattern in which a client (a user of the present invention), a payment company, and a receiving company conduct cross-border transaction through a clearing system. In conventional clearing systems, only a specific bank can make a request of cross-border transaction to a clearing system. The specific bank must have registered to the clearing system. Individual companies and users cannot directly make a request of cross-border transactions in the clearing system. The reason is that there is no communication system which may enable individual users or companies to apply or request cross-border transaction in a clearing system. Conventional communication systems for cross-border transactions can only be used by registered or participating banks, which may use SWIFT to communicate. This kind of communication system is relatively closed and may only be used by relatively few users or entities. Because of these reasons, individual users and companies can only make a request of cross-border transaction through banks which may use SWIFT message to communicate complicated transactions details. The present invention provides cross-border transaction platform in which individual users and companies such as any legal person and legal entity may directly make cross-border transaction requests to the clearing system. The clearing system may match the optimal payment company and receiving company for the applicant of the cross-border transactions, and may initiate the cross-border transactions when the user has paid the corresponding payment. As such, the present invention avoids complicated wiring procedures in conventional cross-border transactions model and so as to substantially increase the effectiveness and efficiency of cross-border transactions.

Moreover, the present invention is applicable to official currency mode and digital currency mode , and they may supplement each other so as to make the system more secure when dealing with unbalanced business.

### DETAILED DESCRIPTION OF THE PREFERRED EMBODIMENT

Suppose a client A1 who are in country A would like to send payment through a payment processing company also located in country A to a bank account in a bank B3 located in country B, and further suppose that one unit of a predetermined digital currency has a value equal to $100 U.S. dollars. A typical cross-border payment processing procedures may comprise the following steps:

1. Client A1 submits an order. Client A1 may directly conduct a corresponding cross-border payment transaction through a clearing system, or designate a company to conduct the corresponding cross-border payment;

2. When client A1 submits the order, if he chooses to conduct the transaction directly, the cross-border payment and clearing system will try to match and find a member company B2 located in country B as a transaction counterparty company for the transaction. The clearing system may find a suitable company B2 based on the information contained in the order, such as payee country, payee bank, payee account, payment currency, and payment amount etc. The clearing system may also match a suitable company B2 based on some financial information thereof such as the security status, total settlement amount, and the availability of a bank account in bank B3. Similarly, the clearing system may also select a transaction processing company A2 located in country A to carry out the counterparty transaction with company B2 to complete the cross-border payment transaction. The selection criteria will be substantially similar to that of choosing the transaction processing company B2. If client A1 chooses to use a designated transaction processing company to complete the corresponding cross-border payment, the clearing system will, depending on the availability of security deposits, inform if the corresponding cross-border transaction may be initiated. If the security deposits is not enough to pay the counterparty company, the clearing system may initial a financing service and transfer of funds or digital currency from an internal bank or use other designated methods to fund the security deposit account so as to ensure that there will be sufficient security deposit to initiate the cross-border transaction. Alternatively, the clearing system may select and match other transaction processing companies to carry on another counterparty transaction to complete the corresponding cross-border transaction. In other words, the two companies A2 and B2 as described below may be a payment processing company which is designated by client, or a transaction processing company which is selected and matched by the clearing system;

3. Client A1 makes a money transfer of US$5000 payment and the corresponding processing fee to a designated bank account of company A2;

4. When client A1 has made the money transfer, three corresponding transaction records may be created. These transaction records are kept and maintained in the account of the company A2 and B2, and the clearing system respectively, wherein each of the transaction records includes the corresponding bank account information, the processing fees for each company/transaction counterparty, and the amount of digital currency which may be needed to be traded;

5. The clearing system may, according to the above-mentioned transaction records, authorize or lock in the security deposits of the transaction processing company A2 and B2: 50 units of a predetermined digital currency or US$5000 and etc.;

6. Company A2 deducts the processing fee from the payment paid by client A1, and exchanges the remaining balance to the predetermined digital currency through a local digital currency exchange platform, the local digital currency exchange platform may be the a digital currency exchange platform located in the country or state of origin of the company A2. Alternatively, the local digital currency exchange platform may be an inter transaction processing company trading platform in the clearing system. The total amount may slightly little more than 50 units of digital currency. Excess dollar amount may be kept by receiving company B2 as processing fee. The processing fee may also be kept in the form of digital currency by exchanging all the payment from client A1. When there is enough digital currency, no exchange is necessary;

7. Company A2 makes payment of the above-mentioned digital currency (a little bit more than 50 units of digital currency) to a digital wallet of company B2;

8. When company B2 has received the digital currency from company A2, company B2 may initiate the release of the security deposit belonging to company A2 and being locked through the clearing system;

9. At the same time, the company B2 may exchange all of the digital currency back to dollar, which may be a little bit more than $5000. The excess amount is the processing fee of company B2 (obviously, company B2 may exchange only 50 units of digital currency to dollar, wherein the excess amount of digital currency may be kept in the form of digital currency and stored in a digital wallet as the processing fee of company B2). It is obvious that when there is not enough digital currency, keeping some digital currency is necessary.

10. Company B2 transfers $5000 to the bank account in bank B3 designated by client A1 in the order;

11. Company B2 transmits a transfer receipt back to company A2. Company A2 notifies the clearing system that the cross-border transaction has been completed, and releases the security deposits of the company B2;

12. If, within a predetermined period of time, company B2 does not receive the digital currency paid by the company A2, the clearing system is configured to reimburse the company B2 corresponding amount due from the security deposits paid by the company A2 in which the amount due may be equal to $5000 or 50 units of the predetermined digital currency to a bank account designated by the company B2; and

13. If, within a predetermined period of time, the company A2 does not receive a confirmation receipt issued by the company B2 regarding the transfer of $5000 into the bank account set up in bank B3 and designated by client A1, the clearing system is configured to reimburse the company A2 the corresponding amount due from the security deposits paid by the company B2 in which the amount due may be equal to $5000 or 50 units of the predetermined digital currency to a bank account designated by the company A2.

The key point is: when client A1 has ordered a cross-border transaction, three identical transaction receipts will be generated and sent to the company A2, the company B2, and the clearing system respectively. It is worth mentioning that each transaction counterparty of the cross-border transaction should have a certain amount of legal tender or digital currency apart from the required security deposits. As a result, each of the transaction counterparty in a cross-border transaction does not need to wait for the payment by the other side to arrive. Rather, each transaction counterparty may proceed to make transfer of legal tender or digital currency when they have received the transaction record information from the system. As such, the efficiency and speed of cross-border transaction may be greatly enhanced. The risks involved in transaction counterparty can be adequately compensated and secured by the relevant security deposits by the clearing system.

In other words, steps 6, 7, 9 and 10 described above may be completed simultaneously. That is, when client A1 has completed submitting a cross-border transaction order and paid, the company B2 may immediately make a transfer of $5000 to the bank account in bank B3 designated by client A1, sell 50 units of the predetermined digital currency and wait for the same amount of digital currency paid by the company A2 to be transferred thereto. If, within a predetermined period of time, the company B2 does not receive the required digital currency from the company A2, the clearing system may be configured to reimburse the company B2 the amount due from the security deposits paid by the company A2. As such, cross-border transaction may be accomplished in a very rapid and efficient manner. Whenever necessary, the company A2 may also advance payment to the company B2 before client A1 actually pays the company A2.

The forgoing description is the preferred embodiment of the cross-border payment and clearing system and cross-border payment method by submitting an order directly to the clearing system. Obviously, a user may also submit the request through a transaction processing company as mentioned above. The transaction processing company may then order a cross-border transaction on behalf of the user. As such, steps 1, 2 and 3 as described above may be amended to state that after a client has paid the corresponding amount for the cross-border transaction, the transaction processing company may initiate a cross-border transaction through the clearing system. The transaction processing company may assign a transaction counterparty company or let the clearing system to select and match an optimal transaction counterparty company. After that, the subsequent steps of the cross-border transaction and clearing may then be carried out.

With the help of the clearing system, cross-border payments and transactions may be completed in seconds. In this very short period of time, variations in the exchange rate of the digital currency may be neglected. As such, the risks for all the participating parties of the cross-border transactions may be substantially minimized. Moreover, since the exchange and transfer of digital currency can be accomplished very rapidly, the security deposits withheld or locked for each transaction counterparty may also be released or unlocked in a very short period of time.

Obviously, the payment in the counterparty transaction can be complete by the payment and clearing system, and this should resemble the reimbursement process as mentioned above. That is, when client A1 has submitted a payment or clearing order, the company B2 may make a money transfer to the designated bank account in bank B3. However, the company A2 does not transfer the corresponding amount of money or digital currency to the company B2. Rather, the clearing system may deduct the security deposits paid by the company A2 and utilize that amount in terms of dollar amount (or digital currency) to make the corresponding payment (in dollar amount or digital currency) to the bank account or electronic wallet held of the company B2. An exemplary account is the security deposit account of the company B2 in the clearing system. As such, cross-border transaction can also be accomplished.

The present invention, while illustrated and described in terms of a preferred embodiment and several alternatives, is not limited to the particular description contained in this specification. Additional alternative or equivalent components could be used to practice the present invention.

1-14. (canceled)

15. A payment and clearing system, characterizing in that, said system comprises:
a member system comprising a plurality of members, wherein at least one said member of said member system is a transaction processing company which is one of a payment company and a receiving company;
a command transmission and communication system, which includes wireless internet-based command transmission and communication system, for accomplishing communications between two or more of the group consisting of member, clearing system and user, and/or communications between members and between users; and
a business system, wherein one said member of said member system is arranged to carry out counterparty transactions with another member through said business system for conducting a payment or a clearing.

16. The payment and clearing system, as recited in claim 15, wherein said payment and clearing system is configured to create and store at least one of transaction records and accounts.

17. The payment and clearing system, as recited in claim 16, further comprising a transaction counterparty matching system which selects at least one transaction counterparty company for said payment or said clearing, wherein said selected transaction counterparty company is an optimal payment company, an optimal receiving company or an optimal payment company with an optimal receiving company.

18. The payment and clearing system, as recited in claim 17, further comprising an business submission and processing system, wherein an user, which is a member or a non-member and is a legal entity, a natural person or an organization, is arranged to, through said business submission and processing system, submit a payment or clearing transaction request to said clearing system, said clearing system is arranged to process said transaction through at least one of the payment company and the receiving company as designated by the user, or select at least one counterparty to process said payment and clearing transaction, said counterparty company comprise a payment company on said payer said or a receiving company on said payee side.

19. The payment and clearing system, as recited in claim 18, further comprising a member bank, a security deposit system, or a member bank with a security deposit system, which allows a user to open account and put security deposit to the account, said security deposit including at least one of an official currency and a digital currency.

20. The payment and clearing system, as recited in claim 19, further comprising a security deposits management system configured according to the payment and clearing situation to perform at least one of locking, releasing, reimbursing and paying to the corresponding security deposit.

21. The payment and clearing system, as recited in claim 20, further comprising a financing system, for providing financing services to said members.

22. The payment and clearing system, as recited in claim 20, further comprising a currency exchange module configured to exchange a predetermined currency to other another official currency, a digital currency, precious metals or other valuables, or an appropriate bill of lading in barter transaction.

23. A payment and clearing method, comprising the steps of:
(a.1) conducting a payment or clearing transaction by a client through a business submission system and payment;
(a.2) said client initiating said transaction through a clearing system, and specifying a member of said clearing system as a transaction counterparty by himself, or selecting and matching a member of said clearing system as a transaction counterparty by a transaction counterparty matching system for said transaction;
(a.3) paying a corresponding digital currency or legal currency by themself or by a business system or a member bank between the two counterparties from said payment company to said receiving company;
(a.4) transferring the corresponding official currency to said bank account designated by said client above by said receiving company.

24. The method, as recited in claim 23, said step (a.1) is substituted by the step of:
(ac.1) requesting a member of a clearing system to conduct a payment or clearing transaction and payment by a client through a business submission system;
wherein said step of (a.2) is substituted by the step of:
(ac.2) said member initiate said transaction through said clearing system, and specifying another member of said clearing system as a transaction counterparty, or selecting another member of said clearing system as a transaction counterparty by a transaction counterparty matching system for said transaction.

25. The method, as recited in claim 23, wherein said step (a.3) further comprises the step of:
once said counterparty transaction starting, locking said security deposits of said payment company until said order company received corresponding digital currency or legal currency from said payment company.

26. The method, as recited in claim 23, wherein said step (a.3) further comprises the step of locking said security deposits of said order company until said bank account designated by said client earlier received corresponding digital currency or legal currency from said order company or a predetermined period of time out, through said member bank or security deposits system.

27. The method, as recited in claim 23, further comprises the step of: reimbursing a corresponding amount from the security deposit of a transaction counterparty to the other transaction counterparty when the other counterparty fails to pay the corresponding amount of currency as requested in a said counterparty transaction.

28. The method, as recited in claim 23, wherein the step (a.4) is between the step (a.2) and the step (a.3).

29. A payment and clearing system client terminal, comprising a business submission module and a payment module, wherein a user is adapted to submit a payment or clearing transaction request to a payment or clearing system and payment, said user includes at least one of a legal person, a natural person and/or other organizations.

30. The payment and clearing system client terminal, as recited in claim 29, being configured to create and store transaction records for all or a part of the transactions or payments.

31. The payment and clearing system client terminal, as recited in claim 30, further comprising an appointment module, said appointment module being arranged to appoint a member of said payment and clearing system to carry out said payment of clearing transaction, said appointment includes appointing a member of said payment and clearing system to conduct the said payment or clearing transaction, or to work as the said payment company or said receiving company for carrying out said payment and clearing transactions.
